(19) United States
(12) Patent Application Publication
(10) Pub. No.: US 2019/0042956 A1
(43) Pub. Date: Feb. 7, 2019

(54) AUTOMATIC CONFIGURABLE SEQUENCE SIMILARITY INFERENCE SYSTEM

(71) Applicant: Intel Corporation, Santa Clara, CA (US)

(72) Inventors: Yen-Min Huang, Cary, NC (US); Sidharth Thakur, Cary, NC (US); Cameron Byrd, Raleigh, NC (US)

(73) Assignee: Intel Corporation, Santa Clara, CA (US)

(21) Appl. No.: 15/893,315

(22) Filed: Feb. 9, 2018

(51) Int. Cl. G06N 5/04; G06F 17/30; G06N 99/00; G06N 7/08

(52) U.S. Cl. CPC G06N 5/04; G06F 17/3053; G06N 7/08; G06N 99/005; G06F 17/30961

(57) ABSTRACT

An embodiment of a semiconductor package apparatus may include technology to test a target query for one or more similarity metrics over a range of parameters for one or more sets of sequence related information, a multi-domain sequence model, and one or more training routines, select a set of parameters based on a result of the test, and automatically configure the multi-domain sequence model to adapt to one or more of respective data sets, respective prediction tasks, and respective recommendation tasks based on the selected parameters. Other embodiments are disclosed and claimed.

### TECHNICAL FIELD

Embodiments generally relate to machine learning. More particularly, embodiments relate to an automatic configurable sequence similarity inference system.

### BACKGROUND

A machine learning (ML) network may provide a prediction or classification based on input data. The ML network may be trained with a manually curated set of training data, training algorithms, parameters, models, etc. selected for a particular application domain. However, existing solutions were designed to solve specific problems associated with a specific domain, e.g., ML modeling and analysis techniques developed for specific time-series data/sequential data. The disadvantages of domain specific solutions are worsened when dealing with additional temporal dimension in input data.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3B are flowcharts of an example of a method of automatically configuring a model according to an embodiment;

FIG. 4 is a block diagram of an example of an automatic configurable sequence similarity inference system according to an embodiment;

FIG. 5 is a flowchart of an example of a method of processing data according to an embodiment;

FIG. 6 is a flowchart of an example of a method of a transformation process for time-series data according to an embodiment;

FIGS. 7A and 7B are illustrative diagrams of universal sequence models according to embodiments;

FIG. 8 is an illustrative diagram of an example of a prefix table according to an embodiment;

FIG. 9 is an illustrative diagram of an example of a context tree according to an embodiment;

FIG. 10 is an illustrative diagram of an example of updating of a context tree according to an embodiment;

FIG. 11 is an illustrative diagram of another example of updating of a context tree according to an embodiment;

FIG. 12 is an illustrative diagram of an example of building of a context tree according to an embodiment;

FIG. 13 is an illustrative diagram of an example of multivariate training according to an embodiment;

FIG. 14 is a flowchart of an example of a method of multivariate sequence classification according to an embodiment;

FIG. 15 is a flowchart of an example of a method of multivariate next-state prediction according to an embodiment;

FIG. 16 is a flowchart of an example of a method of data transformation and splits for automatic configuration according to an embodiment;

FIG. 17 is a flowchart of an example of a method of selecting a best training algorithm according to an embodiment;

FIG. 18 is a flowchart of an example of a method of selecting a best context-tree length according to an embodiment;

FIG. 19 is a flowchart of an example of a method of selecting a binning number according to an embodiment;

FIG. 20 is a flowchart of an example of a method of variable selection according to an embodiment;

FIGS. 21A and 21B are block diagrams of examples of automatic configurator apparatuses according to embodiments;

FIG. 22 is a block diagram of an example of a processor according to an embodiment; and

FIG. 23 is a block diagram of an example of a system according to an embodiment.

### DESCRIPTION OF EMBODIMENTS

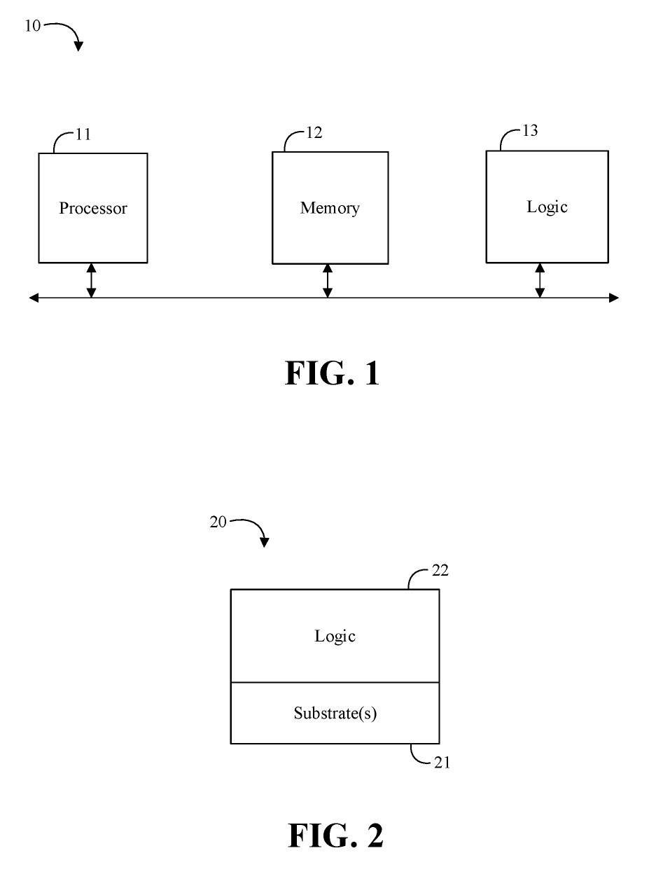

Turning now to FIG. 1, an embodiment of an electronic processing system 10 may include a processor 11, memory 12 communicatively coupled to the processor 11, and logic 13 communicatively coupled to the processor 11 to test a target query for one or more similarity metrics over a range of parameters for one or more sets of sequence related information, a multi-domain sequence model (e.g., a universal sequence model), and one or more training routines, and select a set of parameters based on a result of the test. In some embodiments, the logic 13 may be further configured to automatically configure the multi-domain sequence model to adapt to one or more of respective data sets, respective prediction tasks, and respective recommendation tasks based on the selected parameters. In some embodiments, the one or more similarity metrics may include multi-domain similarity metrics (e.g., universal similarity metrics). For example, the multi-domain similarity metrics may include averaged log-loss similarity metrics. In some embodiments, the multi-domain sequence model comprises a variable order context-tree model. In some embodiments, as explained in more detail below, the sequence related information may include one or more of time series data, temporal event sequence information, and symbolic sequence information. In some embodiments, the logic 13 may be located in, or co-located with, various components, including the processor 11 (e.g., on a same die).

Embodiments of each of the above processor 11, memory 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the logic 13, testing the target query for universal similarity metrics over a range of parameters, transforming the sequence information, selecting training algorithms, select the set of parameters based on results of the test, automatically configuring the universal sequence model, etc.).

Turning now to FIG. 2, an embodiment of a semiconductor package apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to test a target query for one or more similarity metrics over a range of parameters for one or more sets of sequence related information, a multi-domain sequence model (e.g., a universal sequence model), and one or more training routines, and select a set of parameters based on a result of the test. In some embodiments, the logic 22 may be further configured to automatically configure the multi-domain sequence model to adapt to one or more of respective data sets, respective prediction tasks, and respective recommendation tasks based on the selected parameters. In some embodiments, the one or more similarity metrics may include multi-domain similarity metrics (e.g., universal similarity metrics). For example, the multi-domain similarity metrics may include averaged log-loss similarity metrics. In some embodiments, the multi-domain sequence model comprises a variable order context-tree model. In some embodiments, as explained in more detail below, the sequence related information may include one or more of time series data, temporal event sequence information, and symbolic sequence information. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

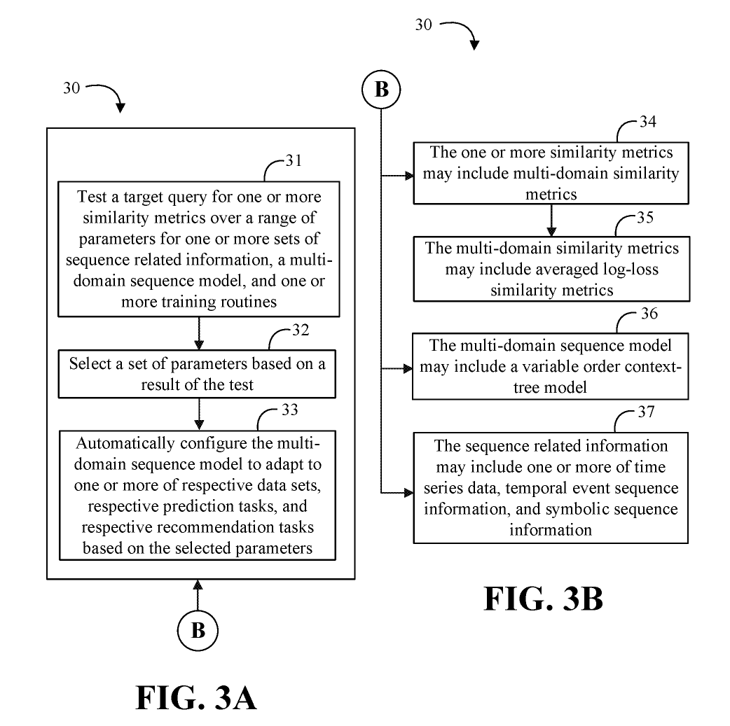

The apparatus 20 (FIG. 2) may implement one or more aspects of the method 30 (FIGS. 3A to 3B), or any of the embodiments discussed herein. In some embodiments, the illustrated apparatus 20 may include one or more substrates (e.g., silicon, sapphire, gallium arsenide) and logic (e.g., transistor array and other integrated circuit/IC components) coupled to the substrate(s). The logic may be implemented at least partly in configurable logic or fixed-functionality logic hardware. In one example, the logic may include transistor channel regions that are positioned (e.g., embedded) within the substrate(s). Thus, the interface between the logic and the substrate(s) may not be an abrupt junction. The logic may also be considered to include an epitaxial layer that is grown on an initial wafer of the substrate(s).

Turning now to FIGS. 3A to 3B, an embodiment of a method 30 of automatically configuring a model may include testing a target query for one or more similarity metrics over a range of parameters for one or more sets of sequence related information, a multi-domain sequence model, and one or more training routines at block 31, and selecting a set of parameters based on a result of the test at block 32. Some embodiments of the method 30 may further include automatically configuring the multi-domain sequence model to adapt to one or more of respective data sets, respective prediction tasks, and respective recommendation tasks based on the selected parameters at block 33. In some embodiments, the one or more similarity metrics may include multi-domain similarity metrics at block 34. For example, the multi-domain similarity metrics may include averaged log-loss similarity metrics at block 35. In some embodiments, the multi-domain sequence model may include a variable order context-tree model at block 36. In some embodiments, the sequence related information may include one or more of time series data, temporal event sequence information, and symbolic sequence information at block 37.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 20 to 25 below. Embodiments or portions of the method 30 may be implemented in firmware, applications (e.g., through an application programming interface (API)), or driver software running on an operating system (OS).

Some embodiments may advantageously provide an automatic configurable sequence similarity inference system. ML may be important for various intelligent software applications and/or devices. With many different application domains, however, scientists and engineers may dedicate a large amount of time to develop mostly single-domain application solutions for specific problems. Advantageously, some embodiments may provide a multiple-domain or universal domain sequence similarity inference system.

Some other ML and/or data analysis systems may be domain specific. Those skilled in the art may consider that there is no single prediction algorithm that may be optimal for all problems. Accordingly, a significant amount of a data scientist's time may be spent on understanding characteristics of the data, cleansing and normalizing the data, selecting proper parameters, features, and models for analysis and prediction. These steps may often be iterative and necessary to achieve good results. The problem may be exacerbated when dealing with additional temporal dimensions in the data. Such data may include time-series/sequential data existing in many application domains dealing with sensor readings, discrete events, DNA sequences, language processing, etc. Many modeling and analysis techniques have been developed for various domain specific time-series/sequential data. Without disregarding the potential usefulness of domain-specific knowledge, some embodiments may provide a domain independent sequence similarity inference system that may advantageously be automatically configured to achieve good accuracies for major prediction tasks on sequences, such as classification and next-state/event prediction. Some embodiments may also be extended to other tasks such as finding nearest-neighbors, clustering, outlier detection, etc. based on the abstraction of similarity inferences. Some embodiments may provide comparable analysis results to domain-specific counterparts with a significant reduction in the solution development costs.

Because of potential wide applicability and abstraction uniformity, some embodiments may be more readily implemented in hardware for a variety of applications. For example, some embodiments may combine and/or improve a variety of training/modelling techniques to produce an end-to-end universal sequence similarity inference system that may be automatically adapted into a wide range of sequence analysis problems and achieve competitive prediction results as compared to domain specific solutions.

In general, data analysis may be an iterative process in which data scientists examine the data, conduct tests and experiments, select models, adjust parameters, evaluate, and improve the process to reduce prediction errors. Some other systems may automate aspects of the iterative process for specific problems or may utilize meta-learning to select algorithms. These other systems may either not be general enough (e.g., ad hoc for a specific problem) or may be much more complex to set up and configure (e.g., meta-learning). Because of non-uniformity of underlying classifiers, the problem-specific systems may be more difficult to extend. In addition, performance-based selection may tend to be less predictable and may require a wider range of coverage to achieve good selection. Advantageously, some embodiments may provide automatic selection and configuration of training algorithms across one common abstraction and/or representation. In some embodiments, automatic configuration may need to be exercised only once per use case and may be resilient to incremental updates. In addition, some embodiments may be easier to implement. For example, optimizing a collection of training algorithms across a single representation for a hardware implementation may be easier than using a collection of disparate algorithms with different representations.

Some embodiments may provide an end-to-end ML system based on context-tree models and universal similarity metrics that may be configured automatically to adapt to different prediction/recommendation tasks for time-series and sequential event data, achieving high accuracy. Beyond a usage in scalable software systems, a ML component in some embodiments may be a common component embedded into an intelligent devices/software for learning/predicting time-series/sequential event data. For example, some embodiments may provide a universal ML platform for time-series/sequential event data based on a set of training algorithms, a variable-order context-tree model, and averaged log-loss similarity metrics. In some embodiments, a universal learning model may be automatically configured to adapt to the data sets and various prediction/recommendation tasks by selecting parameters from a bootstrapped universal model for the target queries. Advantageously, some embodiments may provide a complete solution which produces high quality results with much less human effort.

Some embodiments may provide an automatic configurable sequence similarity inference system with a framework that may achieve high accuracy (e.g., comparable to domain-specific systems) for a variety of prediction/recommendation tasks for a wide range of time-series/sequential event data with little domain specific tuning effort through an automatic configuration process. In some embodiments, the combination of training algorithms, context-tree model, universal similarity metrics, and automatic configuration may provide good accuracy with little human effort.

Some embodiments of a ML system may include a time-series data transformation, a universal sequence model, similarity metrics, training algorithms, built-in queries, and an automatic configurator for selecting parameters. In some embodiments, the process may start with the automatic configurator using a portion of the training data to test the target query using the similarity metrics over a range of parameters for the time-series data transformation, the universal sequence model, and the training algorithms, to select the best set of parameters for training, testing, and evaluating the final model. In some embodiments, a sequence may refer to a set of related events, movements, or things that follow each other in a particular order. For example, a sequence may include time-series data (e.g., sensor data), temporal event sequences (e.g., calendar events), and/or symbolic sequences (e.g., DNA, English sentences, etc.). In some embodiments, a similarity inference may reach a conclusion or recommendation on the basis of evidence and reasoning using similarity metrics. For example, a similarity inference may cover applications in classifying or clustering sequences (e.g., by finding sequences with similar patterns) and recommending next items in sequences (e.g., extending existing partial sequences).

System Overview Examples

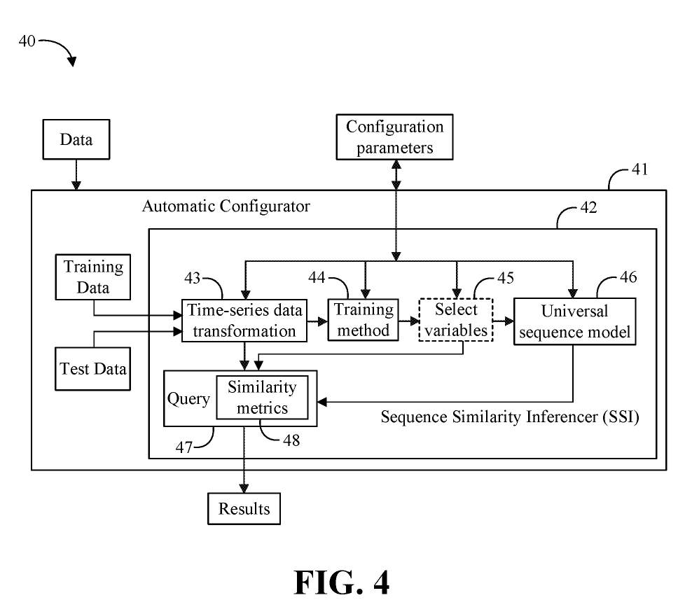

Turning now to FIG. 4, some embodiments may be physically or logically arranged as one or more modules. For example, an embodiment of an architecture for an automatic configurable sequence similarity inference system 40 may include an automatic configurator 41 with an embedded sequence similarity inferencer (SSI) 42 subsystem. The SSI 42 may include a time-series data transformation module 43, a set of training algorithms 44, a variable selector 45, a universal sequence model 46, and a set of built-in queries 47 including similarity metrics 48. For example, the SSI 42 may be implemented with any suitable inference engine technology and may include technology to select best parameter values (e.g., training algorithms, configuration parameters, variables, etc.). The SSI 42 may also include technology to train the final model and to predict results.

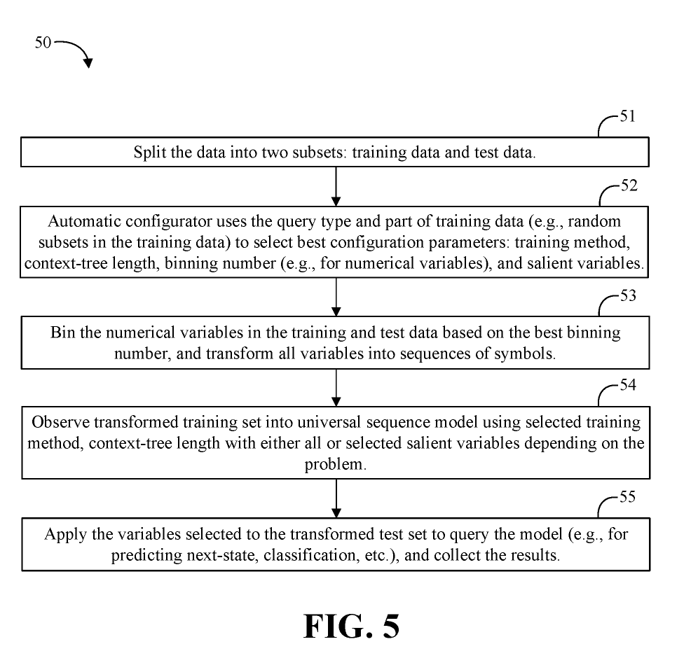

Turning now to FIG. 5, an embodiment of a method 50 of processing data (e.g., with the system 40) may include splitting an input data set into two subsets including training data and test data at block 51. At block 52, the method 50 may then include having the automatic configurator use the query type and part of the training data (e.g., a random subset in the training data) to select best configuration parameters including a training method, a context-tree length, a binning number (e.g., for numerical variables), and salient variables. At block 53, the method 50 may include binning the numerical variables in the training and test data based on the best binning number, and transforming all variables into sequences of symbols. At block 54, the method 50 may include observing transformed training set into the universal sequence model using the selected training method, context-tree length with either all or selected salient variables depending on the problem. At block 55, the method 50 may include applying the variables selected to the transformed test set to query the model (e.g., for predicting next-state, classification, etc.), and collecting the results.

Time-Series Data Transformation Examples

Data binning may refer to a data-processing technique to group values into bins. Data binning may be used to cluster values and tame noise and variance in the data. Some embodiments may apply one or more binning techniques to map numerical values into bins represented by a finite set of symbols (e.g., alphabets or small integers). Any suitable binning techniques may be utilized depending on the application. In some embodiments, the binning technique may meet the following criteria: domain independent binning (e.g., only based on the numerical values in the data); suitable for online processing (e.g., to minimize restrictions on use cases); and fast and scalable (e.g., time-series data may be large in some applications). Some embodiments may utilize a symbolic approximation (SAX) binning technique to bin numerical variables. SAX may be a quantile binning technique to map numerical values into symbols such as ‘A’, ‘B’, ‘C’, ‘D’, and ‘E’ (e.g., or integers 1-5). A small binning number (e.g., 3 to 7) may be sufficient for most classification problems. In some embodiments, the numerical values may be binned based on the following equations:

$$\begin{matrix}\hat{{x}_{l}} = \frac{{x}_{i} - μ}{σ} & [ Eq . 1 ] \\ {β}_{j} \leq \hat{{x}_{l}} < {β}_{j + 1} \to {s}_{j} & [ Eq . 2 ]\end{matrix}$$

Break points, β₁, . . . , β₄ may correspond to [−0.84, −0.25, 0.25, 0.84] and average values may be binned as 3(C), while medium low numbers may be binned as 2(B), very low numbers may be binned as 1(A), medium high numbers may be binned as 4(D), and very high numbers may be binned as 5(E). The best binning number for the SAX binning technique may be determined by the automatic configurator (e.g., as described below).

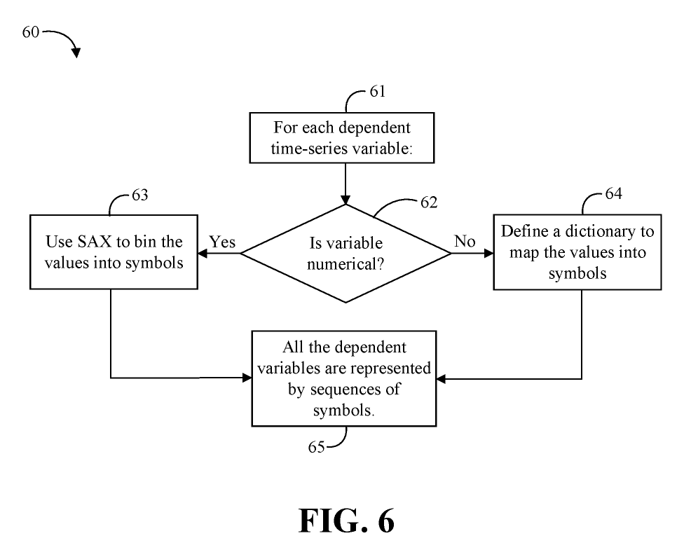

Turning now to FIG. 6, an embodiment of a method 60 of a transformation process for time-series data with both numerical and categorical values may include for each dependent time-series variable at block 61 determining if the variable is numerical at block 62. If so, the method 60 may use SAX to bin the values into symbols at block 63. Otherwise, the method 60 may define a dictionary to map the values into symbols at block 64. Then at block 65, all the dependent variables may be represented by sequences of symbols.

Universal Sequence Model Examples

To increase or maximize applicability, in some embodiments the representation of a model may be general and flexible in capturing characteristics of a wide range of sequences, but may not be open-ended. For example, an applicable sequence may assume that an item in the sequence depends only on a finite number of previous items (e.g., small integer number in practice), and/or that the sequences possesses static or stable properties (e.g., no divergent, chaotic sequences). In some embodiments, the universal sequence model may be based on a variable-order Markov model (VOM), also known as context trees. Some embodiments of the model may include the following properties: capable of modeling arbitrary high order sequences; resilient to time/phase variances in sequence (only current and preceding states matter); compact knowledge representation of sequences; and/or fast and scalable construction.

In some embodiments, the model may capture occurrences of unique prefixes in training sequences. The model may be represented as a prefix tree (e.g., or a context tree) where paths in the tree are prefixes. Each node in the tree may store the last symbol of a prefix represented by the path from a root node “ε” and the frequency count for the prefix. The model may also be represented as a hash table with prefixes as the keys and occurrence counts as the values. In various embodiments, a context tree and a hash table may provide equivalent representations of the model. Depending on the usage, one representation may be more convenient or more efficient than the other. For example, if the application needs to check for existence of a prefix, a hash table may provide a constant time lookup. On the other hand, some embodiments may benefit from checking a context tree for sorted prefixes. Accordingly, some embodiments of a universal sequence model may be referred to as a prefix table and/or a context tree.

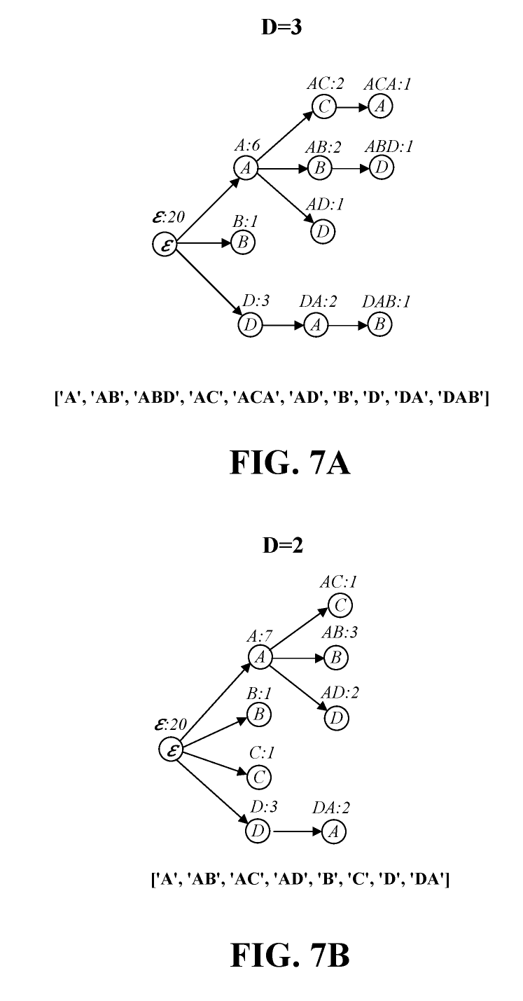

Turning now to FIGS. 7A and 7B, embodiments of illustrative universal sequence models may be constructed based on a VOM with Lempel-Ziv-78 compression (LZ78). For example, the illustrated models may be based on one or more of the following equations:

$$\begin{matrix}\hat{P} ( σ \vert {s}_{n - D + 1}^{n} ) = \{ \begin{matrix}\hat{P} ( σ \vert {s}_{n - D + 1}^{n} ) , if {s}_{n - D + 1}^{n} σ trained . \\ \hat{P} ( escape \vert {s}_{n - D + 1}^{n} ) . \hat{P} ( σ \vert {s}_{n - D + 2}^{n} )\end{matrix} & [ Eq . 3 ] \\ ( σ \vert s ) = \frac{N ( s σ )}{\vert {Σ}_{s} \vert + Σ N ( s {σ}^{′} )} & [ Eq . 4 ] \\ ( escape \vert s ) = \frac{\vert {Σ}_{s} \vert}{\vert {Σ}_{s} \vert + Σ N ( s {σ}^{′} )} & [ Eq . 5 ]\end{matrix}$$

where D may correspond to the depth of the tree, and σ may correspond to an input string. For example, the input string σ may correspond to “ABDACADABDAABDACADAB” for both FIGS. 7A and 7B, while the depth D may correspond to three for FIG. 7A (e.g., D=3) and two for FIG. 7B (e.g., D=2).

The maximum depth of the tree may be referred to as context-tree length (e.g., denoted as ‘D’ in FIGS. 7A and 7B), and may limit the length of prefixes that may be stored in the model. The context-tree length may have an impact on the accuracy of predictions, and the best length may be determined by the automatic configurator. For example, the system 40 may build the illustrated context tree models with different context-tree lengths using LZ78 compression to extract prefixes from sequences. Prediction may be performed by partial matching and similarity may be determined via average log-loss. Given an input sequence (e.g., a prefix), for example, the formula \hat{P}(σ|s_{n-D+1}ⁿ) may be utilized to compute the conditional probabilities for the next symbol (σ). For example, Eq. 4 or Eq. 5 may be utilized depending on whether or not the prefix with σ has been observed in the training sequences. This baseline context-tree technique may be referred to herein as CTX-1.

Training Algorithm Examples

In general, given a sequence, training algorithms may build prefixes along the order of sequence to train the model. The algorithm may track a current working prefix (e.g., a segment of symbols), which may get updated as the process moves forward. The existence of a prefix may be checked against the model by either traversing the context tree or looking up in the hash table (e.g., prefix dictionary). If the prefix exists in the model, the frequency count of the prefix may be incremented. Otherwise, the model may be updated by adding a new child node (e.g., or a new key in hash table) with the frequency count of one. Training algorithms used in some embodiments of a SSI may differ in how prefixes were formed and how the counts were updated.

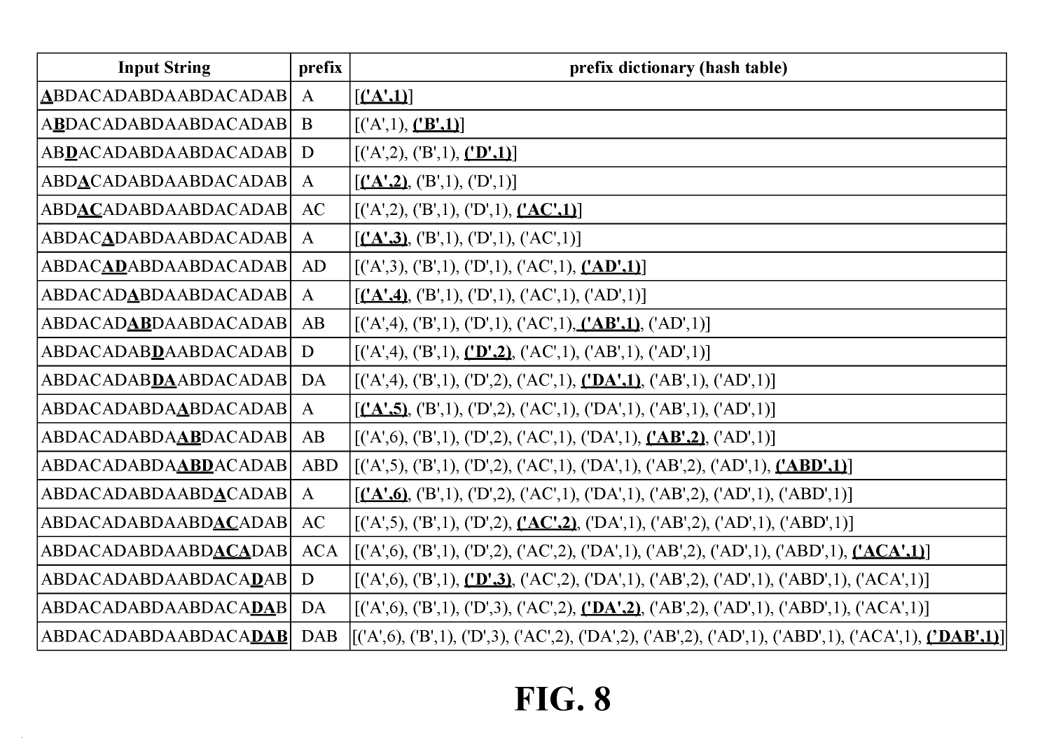

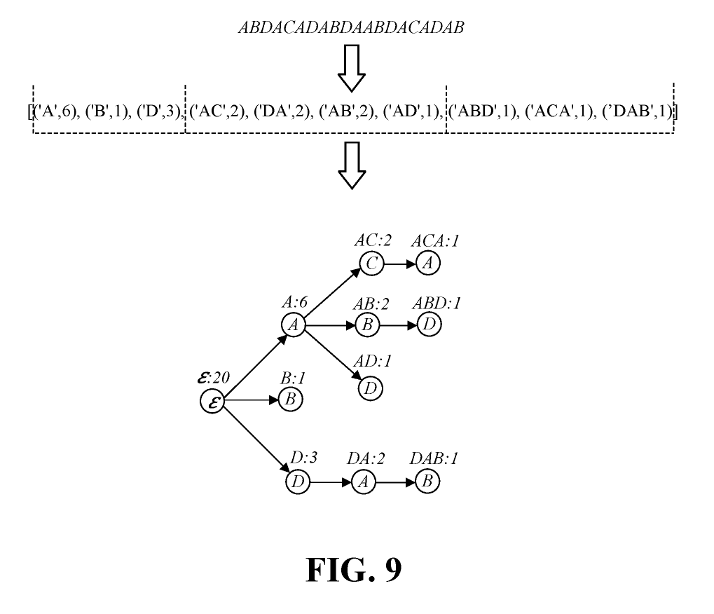

Turning now to FIGS. 8 and 9, embodiments of a prefix table and a context tree may illustrate how the prefix dictionary and context tree may be respectively built using a CTX-1 training algorithm with a context-tree length of three for an input string of “ABDACADABDAABDACADAB.” FIG. 8 shows an example of the training algorithm processing one symbol at time along the sequence to build the prefix table. Each row may highlight the changes in bold and underline (e.g., AB) to the processing state and the prefix dictionary. FIG. 9 shows an example of an equivalent outcome in the context tree. Both space and computation complexity for the training may be linear to the size of the input sequence.

In some embodiments, accuracy of prediction may be closely related to the context-tree length as well as to how prefixes were generated and how counts were updated. Advantageously, some embodiments include the selection of training algorithms as a part of the framework to adapt to the use cases to achieve good results. Some embodiments may include a variety of training algorithms (e.g., including improvements on CTX-1) to achieve much better accuracy performance. Some embodiments may also utilize the automatic configurator to streamline an iterative model tuning process. For example, some embodiments may include four training algorithms in the SSI (e.g., CTX-1 through CTX-4, as discussed below). The CTX-1 algorithm may provide a baseline for comparison. The other algorithms, CTX-2, CTX-3, and CTX-4, may include enhanced variations from CTX-1 to boost prediction performance for the built-in queries (e.g., the main use cases). For example, the CTX-2 algorithm may be similar to the CTX-1 algorithm with a count enhancement. The CTX-3 algorithm, for example, may be similar to the CTX-1 algorithm with a second pass CTX-2 re-training. For example, the CTX-4 algorithm may be trained with fixed size moving window (e.g., prefix) over input sequences. Some embodiments may advantageously provide a flexible framework which may include any of a number of other training algorithm variations.

In some embodiments, similarity inference may be based on the rankings and scores of predictions. The ranking may be represented as an ordered list based on the metrics computed on test sequences. In some embodiments of the SSI, averaged log-loss may be utilized as the similarity metrics (e.g., as discussed below). The averaged log-loss may be computed from conditional probabilities (e.g., see Eq. 3 through 5 above). Advantageously, the different training algorithm may tailor prefixes and occurrence counts to reflect hypotheses encouraging higher ranking of desirable patterns.

CTX-2 Training Algorithm Examples

Classifying sequences effectively may depend on how well the model can relate and differentiate a sequence across class labels. As differences becoming smaller and patterns becoming subtler, classification accuracy may tend to drop due to confusion of the model, especially on boundary cases. For challenging classification, emphasizing rarer patterns (e.g., signature patterns) may help class identification and separation. In general, longer patterns may be rarer. However, the longer the prefix is, the less support it may have as a pattern. Some embodiments may re-enforce the counts along the sub-prefixes leading to a prefix such that common paths across prefixes may be emphasized allowing common patterns emerged in the ranking.

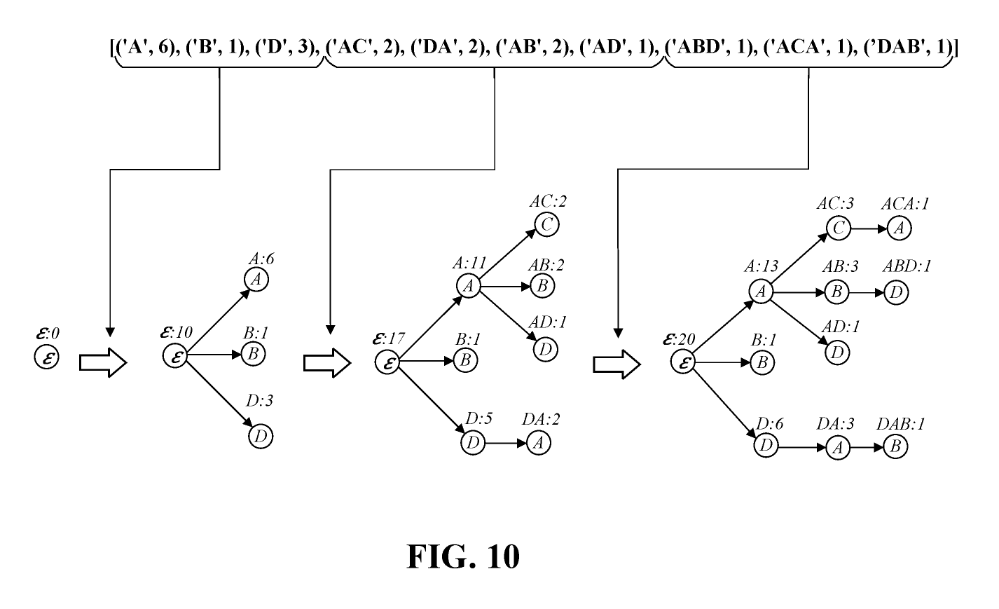

Turning now to FIG. 10, an embodiment of an illustrated updating of a context tree (e.g., D=3) may include an additional count enhancement using the CTX-2 training algorithm. The counts may be re-enforced in CTX-2 from a CTX-1 prefix dictionary. The CTX-2 algorithm may increase the counts of all the sub-prefixes leading to the working prefix based on the counts produced by CTX-1 (e.g., shown in the form of hash table). In some embodiments, the increments from CTX-2 can be accomplished as the CTX-1 algorithm builds the prefix table (e.g., CTX-2 may not require CTX-1 to be completed first).

CTX-3 Training Algorithm Examples

As discussed above, CTX-1 may use an LZ78 scheme iterating over symbols to build up the prefix table incrementally. An artifact of LZ78 may be that to add a prefix, the routine must have previously encountered the sub-prefix leading to the prefix. In other words, the prefix “ABC” would not be added unless “AB” was already in the table. The eventual count for “ABC” would be one less as compared to if “ABC” already exists in the table. The effect may appear inconsequential at the surface since the impact of the effect diminishes as sequence becomes longer. However, for rare patterns or shorter sequences, inference from support of one may be considered incidental while support of two or more may rise up as potential patterns. Because potential missing of longer (distinct) patterns may have a negative impact to the performance, CTX-3 may advantageously address the artifact by capturing longer prefixes better. In some embodiments, CTX-3 may deploy a two-pass approach.

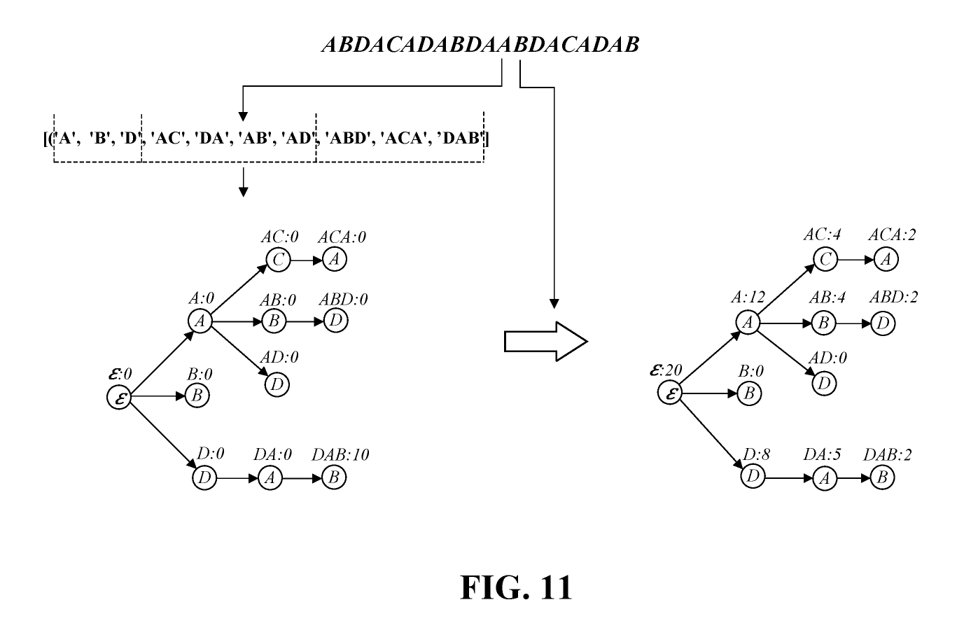

Turning now to FIG. 11, an embodiment of an illustrated updating of a context tree may show the two-pass approach. The first pass may run LZ78 to capture the structure of the context tree (e.g., and/or keys for a prefix table). The second pass may update the frequency counts using CTX-2. By way of comparison, the differences may be noted in the final context trees from FIGS. 10 and 11.

CTX-4 Training Algorithm Examples

A technique for computing moving average and mining sequential patterns may include a moving window technique. Training algorithm CTX-4 may train the model like CTX-1 with prefixes captured in fixed-size moving window (e.g., the window size may be equal to the context-tree length) rather than growing incrementally using LZ78. The moving windows may ensure all prefixes with the size of context-tree length are captured. The CTX-4 training algorithm may provide advantages in predicting a next symbol by minimizing effects of missing patterns due to the artifact of processing prefixes starting at different points or phases.

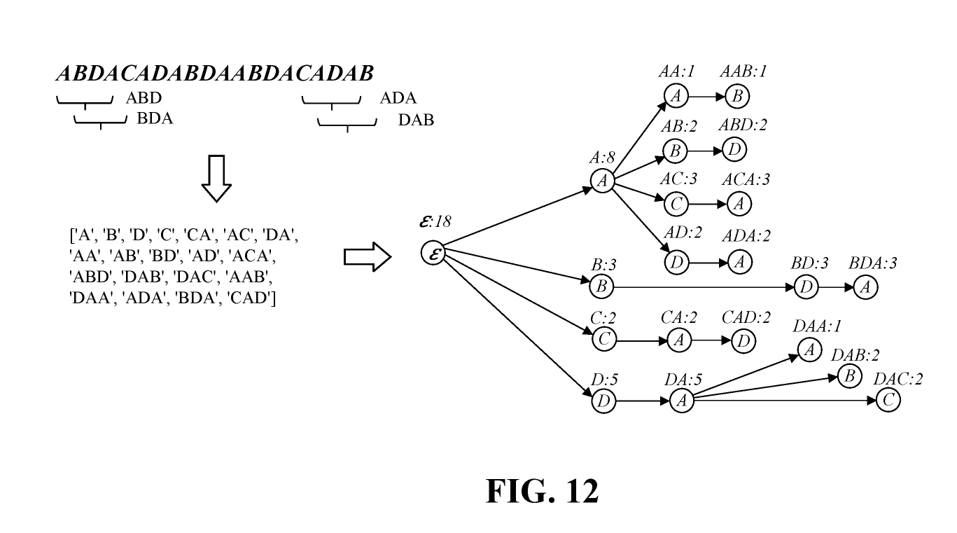

Turning now to FIG. 12, an embodiment of an illustration of building a context tree may illustrate how an example of a CTX-4 training algorithm updates the context tree (e.g., D=3) by applying CTX-1 over subsequences captured by a moving window. The context tree may be built by creating paths for the prefixes and aggregating occurrence counts of the prefixes to the parent nodes.

Similarity Metrics Examples

Similarity metrics may be viewed as distance measures. Specifically, some embodiments may utilize probability-based distance measures to compute probabilities from the model. Any suitable probability-based distance measure may be utilized (e.g., Kullback-Leibler divergence, Bhattacharyya coefficient, Kolmogorov metrics, etc.). Some embodiments may select one universal similarity metric. such that the automatic configurator may not need to perform a computation for selecting a best similarity metric. For example, a similarity metric (e.g., a normalized compression distance) based on Kolmogorov complexity providing an information based compression distance may be a suitable universal similarity metric in accordance with some embodiments.

In some embodiments, a CTX-1 classification may be based on prediction by partial matching (PPM). The CTX-1 training algorithm may use LZ78 compression to build a prefix table and may optimize over a metric called average log-loss. For example, average log-loss may be defined as follows: A test sequence of a variable x with length T may be denoted as x₁^{T}=x₁, x₂, . . . x_{T}. The notation \hat{P}(σ|s) may represent conditional probability distribution of symbol σ with the given sequence s, which may be calculated from the context tree model based on the formula from Eq. 4 above. Minimizing the average log-loss may be considered as equivalent to maximizing a probability assignment for the entire test sequence. Advantageously, some embodiments may use average log-loss to select a most probable next symbol for a sequence as well as for classification. In some embodiments, average log-loss may be determined as follows:

$$l ( \hat{P} , {x}_{1}^{T} ) = - \frac{1}{T} {\sum }_{i = 1}^{T} log \hat{P} ( {x}_{i} \vert {x}_{1} ⋯ {x}_{i - 1} ) \qquad [ Eq . 6 ]$$

In accordance with some embodiments, average log-loss may be effective as a similarity (e.g., distance) measure between two sequences, and may advantageously also be used to identify an amount of regularity (e.g., patterns) in sequences through compressibility (e.g., similar to a Kolmogorov complexity). Some embodiments may advantageously utilize average log-loss as a universal similarity metric.

Built-In Query Examples

Some embodiments may provide a framework for automatic configuration and execution of prediction tasks. The built-in queries may define the problem space for the system. For example, each query may represent a specific type of prediction task. Although more queries may be added, some embodiments may include two built-in queries. In particular, some embodiments may include a multivariate sequence classification query, and a multivariate next-state prediction query. The two queries may exemplify the major use cases of some embodiments of the SSI including, for example, classifying sequences and predicting a next item in a sequence. In addition to the direct use cases, other applications may be supported applying these two queries. For example, the two queries may support applications such as finding nearest neighbors, recommendation, planning, conversation, situation awareness, etc. For different use cases and data, the best parameters and salient variables (e.g., features) may be determined by the automatic configurator.

Examples of Training a Context Tree Model for Multivariate Episodes

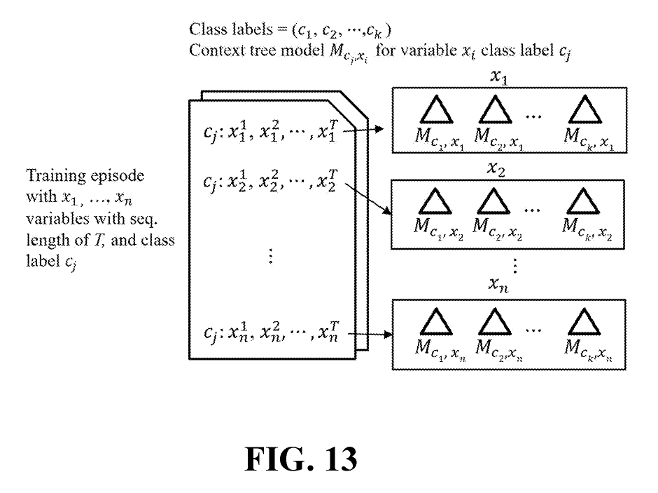

Turning now to FIG. 13, an embodiment of an illustration of multivariate training in an embodiment of a SSI may include multiple training episodes. A multivariate training data set may be composed of multivariate training episodes. Each training episode may include n fixed-length sequences, one sequence per one of the n variables may be denoted as xᵢ, where i=1, . . . , n. For classification problems, sequences in an episode may be associated with one of the k class labels denoted as cⱼ, where j=1, . . . , k. During the training phase, for each variable xᵢ and class label cⱼ, the SSI may create a context tree model Mcⱼ,xᵢ, which may be used to predict class labels. Univariate training may be treated as a special case of multivariate sequence training.

Multivariate Sequence Classification Examples

Sequence classification may include predicting most likely class labels for a given test sequence. There may often be many variables for a given problem space. An embodiment of a multivariate sequence classification query may predict top-m class labels of a given test episode containing the test sequences corresponding to the variables in the problem space. In some embodiments, the ranking of prediction may be performed by tallying the votes of top-m predicted class labels from each variable sequence. The top-m predicted class labels for each variable sequence may be produced by sorting average log-losses computed from the test sequence against k context-tree models for the variable.

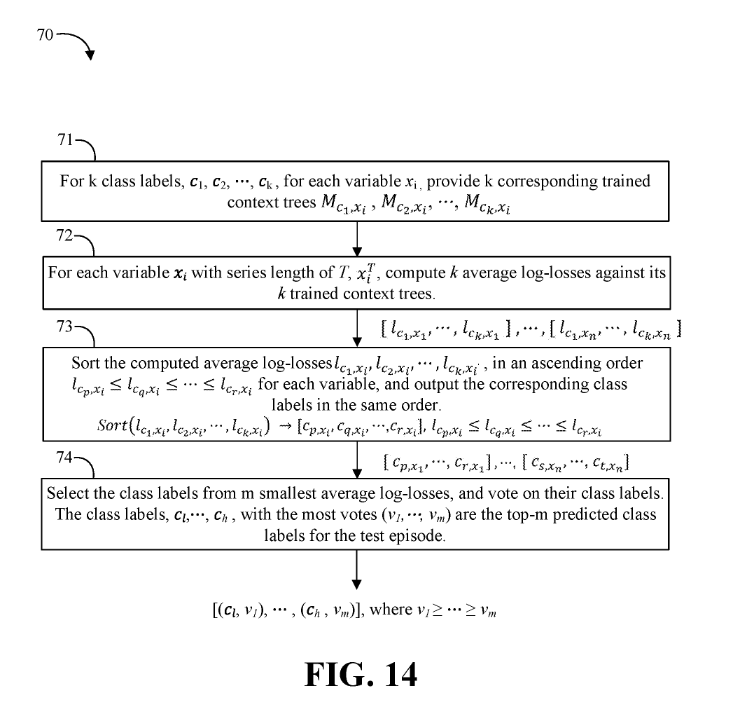

Turning now to FIG. 14, an embodiment of a method 70 of multivariate sequence classification may include, for k class labels, c₁, c₂, . . . ,cₖ, for each variable xᵢ, providing k trained context trees M_{c}_{₁}, xᵢ, M_{c}_{₂}, xᵢ, . . . , M_{c}_{ₖ}, xᵢ at block 71. The method 70 may further include, for each variable xᵢ with series length of T, xᵢ^{T}, computing k average log-losses against its k trained context trees at block 72 (e.g., to determine average log-losses [l_{c}_{₁}_{,x}_{₁}, . . . , l_{c}_{ₖ}_{,x}_{₁}], . . . , [l_{c}_{₁}_{,x}_{ₙ}, . . . , l_{c}_{ₖ}_{,x}_{ₙ}]) The method 70 may then include sorting the computed average log-losses, l_{c}_{₁}_{,x}_{ᵢ}, l_{c}_{₂}_{,x}_{ᵢ}, . . . , l_{c}_{ₖ}_{,x}_{ᵢ}, in an ascending order l_{c}_{ₚ}_{,x}_{ᵢ}≤l_{c}_{_{q}}_{,x}_{ᵢ}≤ . . . ≤l_{c}_{ᵣ}_{,x}_{ᵢ} for each variable, and outputting the corresponding class labels in the same order (e.g., Sort(l_{c}_{₁}_{,x}_{ᵢ}, l_{c}_{₂}_{,x}_{ᵢ}, . . . , l_{c}_{ₖ}_{,x}_{ᵢ})→[c_{p,x}_{ᵢ}, c_{q,x}_{ᵢ}, . . . , C_{r,x}_{ᵢ}], l_{c}_{ₚ}_{,x}_{ᵢ}≤l_{c}_{_{q}}_{,x}_{ᵢ}≤, . . . , ≤l_{c}_{ᵣ}_{,x}_{ᵢ}) at block 73 (e.g., to determine a set of class labels [c_{p,x}_{₁}, . . . , c_{r,x}₁], . . . , [c_{s,x}_{ₙ}, . . . , c_{t,x}_{ₙ}]). The method 70 may further include selecting the class labels from m smallest average log-losses, and voting on their class labels at block 74. For example, the class labels, c₁, . . . , cₕ, with the most votes (v₁, . . . , vₘ) are the top-m predicted class labels for the test episode (e.g., [(c₁, v₁), . . . , (cₕ, vₘ)], where v₁≤ . . . ≤vₘ).

Multivariate Next-State Prediction Examples

The next-state prediction may predict the next symbol (σ) in a given sequence (i.e. given {xᵢ^{T}}, predict {xᵢ^{T+1}=xᵢ^{T}σ}) with the assumption that the current symbol is related to one or more previous symbols in the sequence. Next-state prediction may be used in numerous applications, such as in planning, conversation, fault anticipation, intelligent devices, etc. The problem space often involves multiple variables. To cover most use cases, some embodiments may expand next-state prediction from univariate prediction to multivariate prediction. Next-state prediction without using class labels may be referred to as prediction by partial matching (PPM). In some embodiments, the next symbol may be predicted by taking the last D-1 symbols (e.g., where D corresponds to the context-tree length) in the given test sequence and extending it with one additional symbol from the pool of all symbols (σₗ, . . . , σₛ) forming s test sequences of size of D. For each extended sequence, the query may compute average log-loss and may recommend the last symbol of the extended sequence with the smallest average log-loss. Some embodiments may enhance PPM by taking advantages of class labels (e.g., if available) to provide better predictions using context trees of classes to first recommend the class labels of the test sequence and then use the context trees of recommended classes to predict the next state as in PPM.

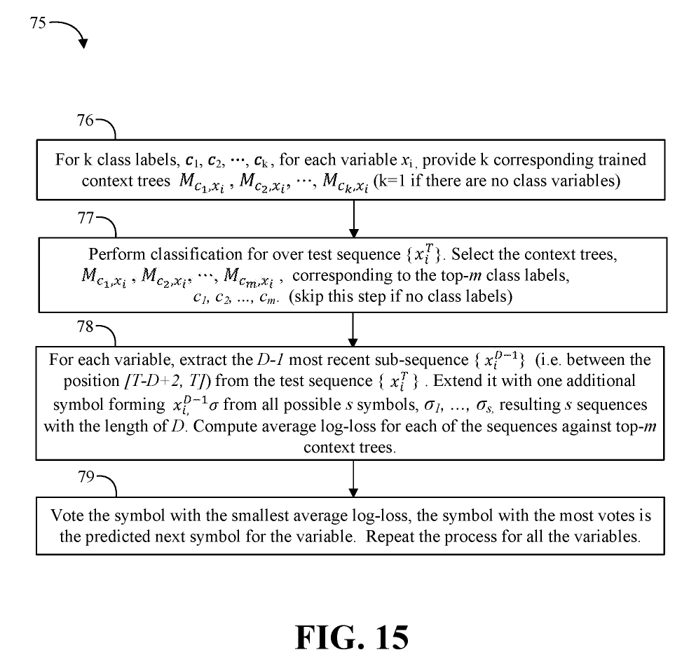

Turning now to FIG. 15, an embodiment of a method 75 of multivariate next-state prediction may include at block 76, for k class labels, c₁, c₂, . . . , cₖ, for each variable xᵢ, providing k corresponding trained context trees M_{c}_{₁}_{,x}_{ᵢ}, M_{c}_{₂}_{,x}_{ᵢ}, . . . , M_{c}_{ₖ}_{,x}_{ᵢ} (e.g., k=1, if there are no class labels). The method 75 may further include performing classification for over a test sequence {xᵢ^{T}}, and selecting the context trees, M_{c}_{₁}_{,x}_{ᵢ}, M_{c}_{₂}_{,x}_{ᵢ}, . . . , M_{c}_{ₘ}_{,x}_{ᵢ} corresponding to the top-m class labels, c₁, c₂, . . . , cₘ. (e.g., skipping this step if no class labels are available) at block 77. For each variable, the method 75 may then include extracting the D-1 most recent sub-sequence {xᵢ^{D-1}} (e.g., between the position [T−D+2, T]) from the test sequence {xᵢ^{t}}, extending the sub-sequence with one additional symbol forming x_{i,}^{D-1}σ from all possible s symbols, σ₁, . . . , σₛ, resulting in s sequences with the length of D, and computing average log-loss for each of the sequences against top-m context trees at block 78. The method 75 may then include voting the symbol with the smallest average log-loss, predicting the symbol with the most votes as the next symbol for the variable, and repeating the process for all the variables at block 79. Blocks 76 and 77 may optionally include performing classification, followed by PPM next-state prediction.

Automatic Configurator Examples

Part of a data scientist's task may include selecting appropriate models, algorithms, and parameters for a data set to achieve good analysis and prediction results. The selection task may be time consuming due to investigating possible combinations in various aspects of the analysis. Given well defined algorithms, a general model, and robust similarity metrics in SSI, the selection task may be automated against the target data set and queries. Advantageously, some embodiments may provide a framework for automatically selecting the best SSI configurations and parameters that may adapt to different sequence data and analysis.

Some embodiments of an automatic configurator may make a selection from a range of parameters by evaluating results experimentally using an embedded SSI and portions of the training data. Some embodiments may advantageously split the training set into an internal training set and a configuration test set to determine a selection of configurations and parameters through evaluating results of the target query on the training data prior to executing final tests and evaluation on the test data. For example, some embodiments may make a three-to-one random split for the internal training set and a two-to-one random split for the configuration test set. The automatic configuration may only need to be performed once per given data set, and may be resilient to incremental data updates. Advantageously, some embodiments may adapt to most sequence data sets and query without human intervention. In production, running the automatic configurator may be beneficial after the initial run if the data characteristics have changed significantly due to updates or accuracy has degraded below a predefined threshold.

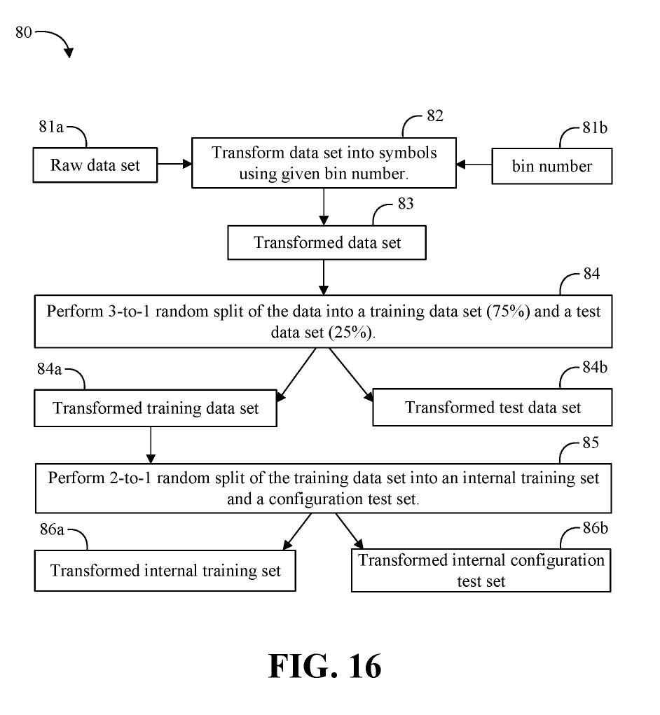

Turning now to FIG. 16, an embodiment of a method 80 of data transformation and splits for automatic configuration may include providing a raw data set at block 81a, providing a bin number at block 81b, and transforming the data set into symbols using the provided bin number at block 82 to provide a transformed data set at block 83. The method 80 may then include performing a 3-to-1 random split of the data into a training data set (e.g., 75% of the data) and a test data set (e.g., 25% of the data) at block 84 to provide a transformed training data set at block 84a and a transformed test data set at block 84b. The method 80 may then include performing a 2-to-1 random split of the transformed training data set 84a into an internal training set and a configuration test set at block 85 to provide a transformed internal training set at block 86a and a transformed configuration test set at block 86b.

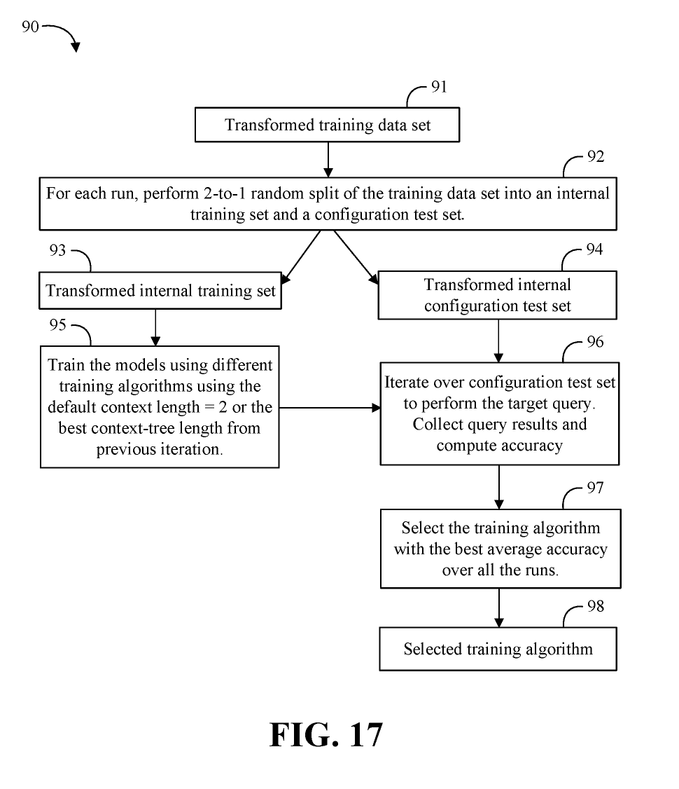

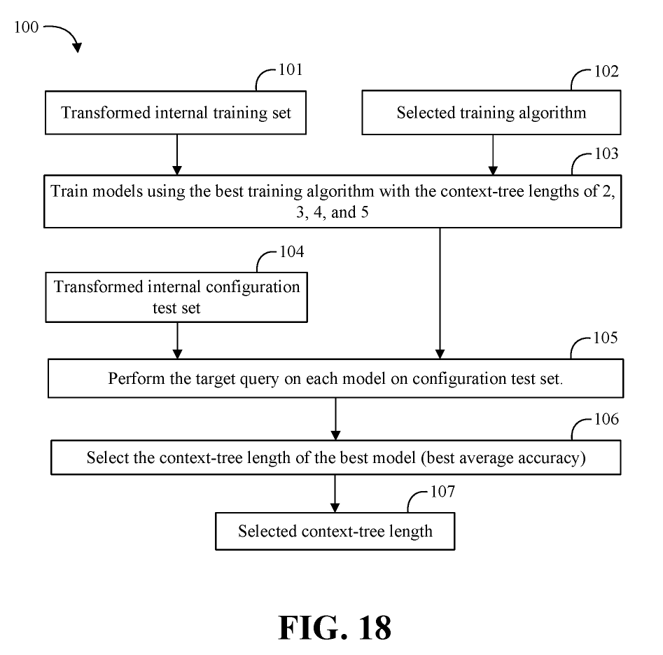

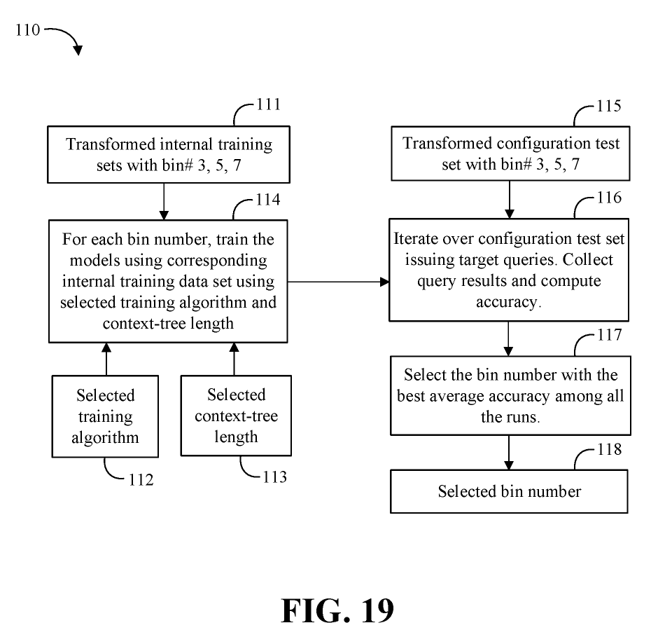

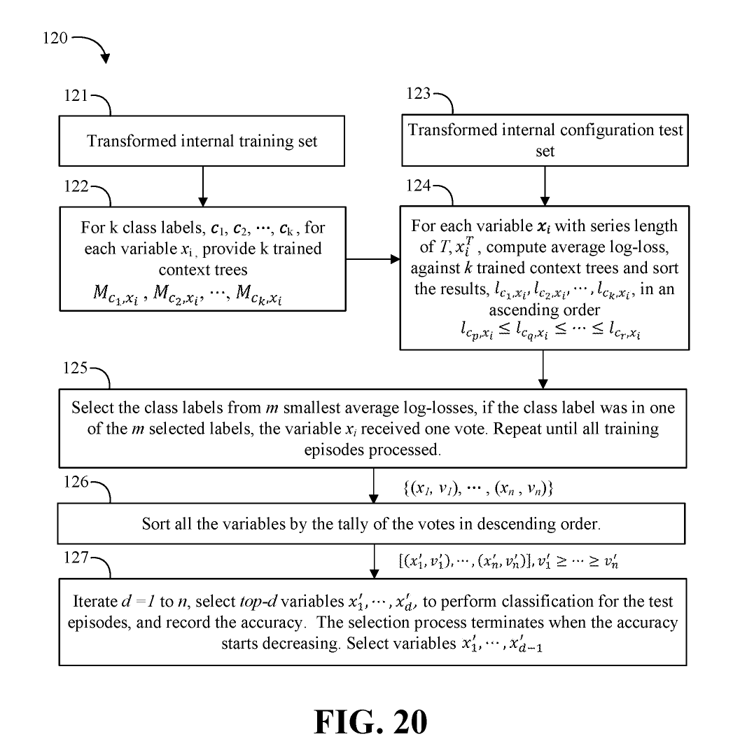

The selection process may be an iterative process over a range of configurations and parameters. The order of processing may be determined by minimizing the computation overheads and speed to convergence of a selection. Default configurations and parameter values may be used if the selection for a specific aspect has not occurred. The selection may follow an order of training algorithm (e.g., see FIG. 17), context-tree length (e.g., see FIG. 18), binning number (e.g., see FIG. 19), and independent variables (e.g., see FIG. 20). Selecting independent variables may only be applicable for data with class labels. Each iteration may inherit the selections from the previous iteration until the selections converge or a maximum number of iterations is reached. For some embodiments, selections may generally converge in a couple of iterations.

Selection of Training Algorithm Examples

Turning now to FIG. 17, an embodiment of a method 90 of selecting the best training algorithm in an automatic configurator may include starting with a transformed training data set at block 91, and, for each run, performing a 2-to-1 random split of the training data set into an internal training set and a configuration test set at block 92 to provide a transformed internal training set at block 93 and a transformed internal configuration test set at block 94. The method 90 may then include training the models using different training algorithms using a default context length=2 or the best context-tree length from a previous iteration at block 95 (e.g., utilizing the transformed internal training set), and iterating over the transformed internal configuration test set to perform the target query, collecting query results, and computing accuracy at block 96. The method 90 may then include selecting the training algorithm with the best average accuracy over all the runs at block 97, and identifying/providing the selected training algorithm at block 98.

Selection of Context-Tree Length Examples

Turning now to FIG. 18, an embodiment of a method 100 of selecting the best context-tree length in an automatic configurator may include starting with the transformed internal training set at block 101 and the selected training algorithm at block 102, and training models using the best training algorithm with the context-tree lengths of 2, 3, 4, and 5 at block 103. The method 100 may then include using the transformed internal configuration test set at block 104 and performing the target query on each model on configuration test set at block 105. The method 100 may then include selecting the context-tree length of the best model (e.g., best average accuracy) at block 106, and identifying/providing the selected context-tree length at block 107.

Selection of Bin Number Examples

Turning now to FIG. 19, an embodiment of a method 110 of selecting the binning number in an automatic configurator may include starting with the transformed internal training set for bin numbers of 3, 5, and 7 at block 111, the selected training algorithm at block 112, and the selected context-tree length at block 113, and for each bin number, training the models using corresponding internal training data set with the selected training algorithm and the selected context-tree length at block 114. The method 110 may then include using the transformed internal configuration test sets with bin numbers of 3, 5, and 7 at block 115, and iterating over the configuration test set issuing target queries, collecting query results, and computing accuracy at block 116. The method 110 may then include selecting the bin number with the best average accuracy among all the runs at block 117, and identifying/providing the selected bin number at block 118.

Selection of Salient Variables Examples

In some embodiments, variable selection (e.g., feature selection) may be included to improve classification performance. Any suitable variable/feature selection technology may be applied in a SSI framework in accordance with some embodiments. For example, minimum-redundancy-maximum-relevance (mRMR) feature selection technology may be adopted for the SSI in some embodiments. However, computation of mRMR can be expensive for combinations of a large number of variables. Some embodiments may find it beneficial to reduce computation overheads as well as improve accuracy by removing highly redundant variables (e.g., over 99% correlation) for various classification algorithms. Any suitable technology may be utilized to reduce the number of variables including, for example, principal component analysis (PCA), correlation matrix, mutual information, etc. Some embodiments may advantageously balance computation overheads and accuracy. For example, some embodiments of a SSI may utilize a greedy algorithm in ranking and selecting variables using average log-loss to measure classification power of variables.

Turning now to FIG. 20, an embodiment of a method 120 of variable selection in an automatic configurator may include starting with a transformed internal training set at block 121, and for k class labels, c₁, c₂, . . . , cₖ, for each variable xᵢ, providing k trained context trees M_{c}_{₁}_{,x}_{ᵢ}, M₂_{₂}_{,x}_{ᵢ}, . . . , M_{c}_{ₖ}_{,x}_{ᵢ} at block 122. The method 120 may then include providing the transformed internal configuration test set at block 123, and for each variable xᵢ with series length of T, xᵢ^{T} in each test episode, computing average log-loss, against k trained context trees and sorting the results, l_{c}_{₁}_{,x}_{ᵢ}, l_{c}_{₂}_{,x}_{ᵢ}, . . . , l_{c}_{ₖ}_{,x}_{ᵢ}, in an ascending order l_{c}_{ₚ}_{,x}_{ᵢ}≤l_{c}_{_{q}}_{,x}_{ᵢ}≤ . . . ≤l_{c}_{ᵣ}_{,x}_{ᵢ} at block 124. The method 120 may then include selecting the class labels from m smallest average log-losses (e.g., if the class label was in one of the m selected labels, the variable xᵢ received one vote), and repeating until all training episodes are processed at block 125 (e.g., providing a set of variables {(x₁, v₁), . . . , (xₙ, vₙ)}). The method 120 may then include sorting all the variables by the tally of the votes in descending order at block 126 (e.g., providing a sorted set of variables [(x₁′, v₁′), . . . , (xₙ′, vₙ′)], v₁′≤ . . . ≤vₙ′) . The method 120 may then include iterating d=1 to n, selecting top-d variables x₁′, . . . , x_{d}′, to perform classification for the test episodes, and recording the accuracy, terminating the selection process when the accuracy starts decreasing, and selecting variables x₁′, . . . , x_{d-1}′ at block 127.

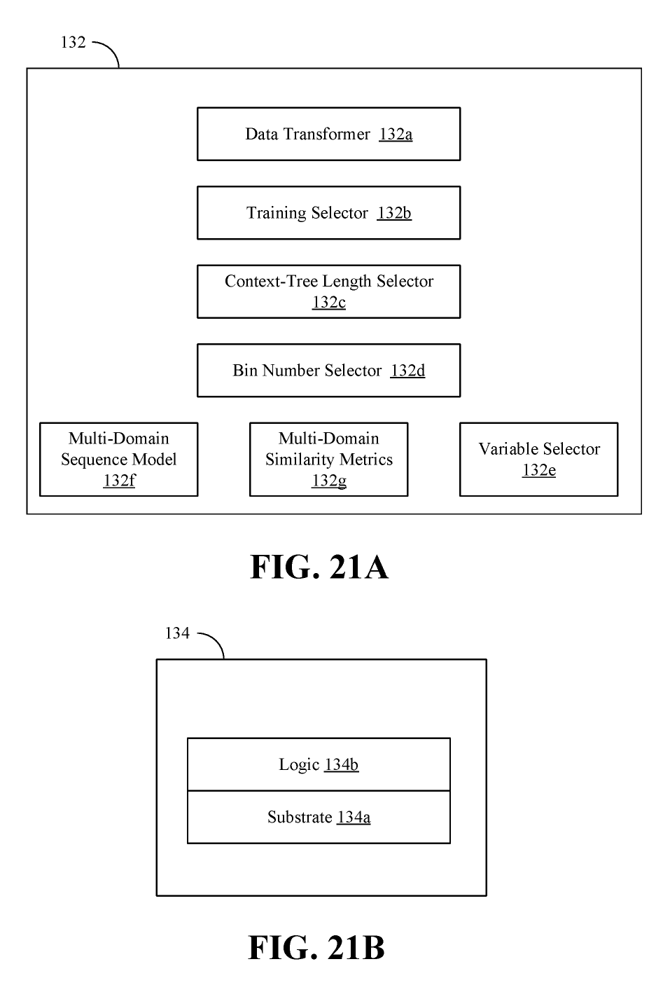

FIG. 21A shows an automatic configurator apparatus 132 (132a-132g) that may implement one or more aspects of the method 30 (FIGS. 3A to 3C), the method 50 (FIG. 5), the method 60 (FIG. 6), the method 70 (FIG. 14), the method 75 (FIG. 15), the method 80 (FIG. 16), the method 90 (FIG. 17), the method 100 (FIG. 18), the method 110 (FIG. 19), and/or the method 120 (FIG. 20). The automatic configurator apparatus 132, which may include logic instructions, configurable logic, fixed-functionality hardware logic, may be readily substituted for the automatic configurator 41 (FIG. 4), already discussed. A data transformer 132a may transform time-series data. A training selector 132b may select a training algorithm. A context-tree length selector 132c may select a context-tree length. A bin number selector 132d may select a bin number. A variable selector 132e may select one or more variables. The automatic configurator apparatus 132 may further include a multi-domain sequence model 132f and multi-domain similarity metrics 132g.

Turning now to FIG. 21B, automatic configurator apparatus 134 (134a, 134b) is shown in which logic 134b (e.g., transistor array and other integrated circuit/IC components) is coupled to a substrate 134a (e.g., silicon, sapphire, gallium arsenide). The logic 134b may generally implement one or more aspects of the method 30 (FIGS. 3A to 3C), the method 50 (FIG. 5), the method 60 (FIG. 6), the method 70 (FIG. 14), the method 75 (FIG. 15), the method 80 (FIG. 16), the method 90 (FIG. 17), the method 100 (FIG. 18), the method 110 (FIG. 19), and/or the method 120 (FIG. 20). Thus, the logic 134b may split an input data set into two subsets including training data and test data. The logic 134b may also instruct an automatic configurator to use the query type and part of the training data (e.g., a random subset in the training data) to select best configuration parameters including a training method, a context-tree length, a binning number (e.g., for numerical variables), and salient variables. The logic 134b may also include technology to bin the numerical variables in the training and test data based on the best binning number, and transform all variables into sequences of symbols. The logic 134b may also observe a transformed training set into the universal sequence model using the selected training method, context-tree length with either all or selected salient variables depending on the problem. The logic 134b may also include technology to apply the variables selected to the transformed test set to query the model (e.g., for predicting next-state, classification, etc.), and collect the results. In one example, the apparatus 134 is a semiconductor die, chip and/or package.

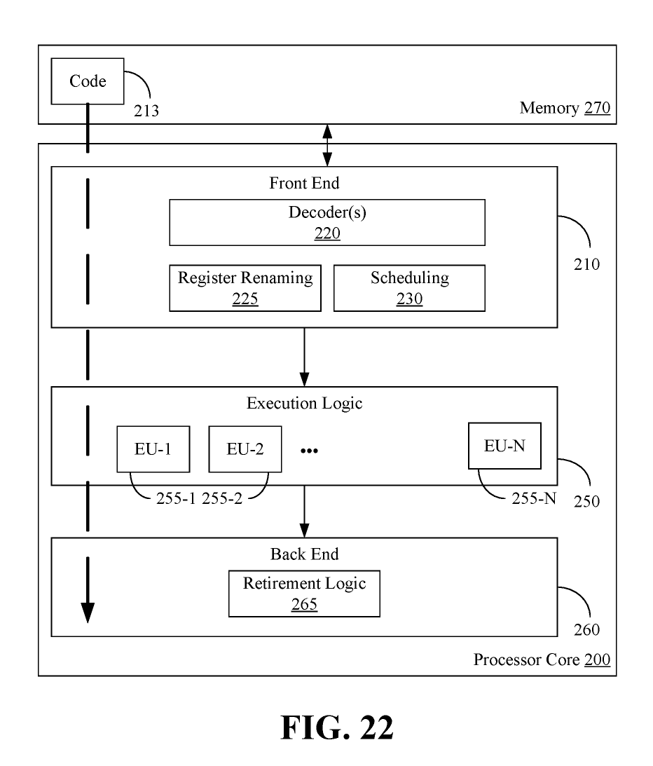

FIG. 22 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 22, a processing element may alternatively include more than one of the processor core 200 illustrated in FIG. 22. The processor core 200 may be a single-threaded core or, for at least one embodiment, the processor core 200 may be multithreaded in that it may include more than one hardware thread context (or “logical processor”) per core.

FIG. 22 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 30 (FIGS. 3A to 3C), the method 50 (FIG. 5), the method 60 (FIG. 6), the method 70 (FIG. 14), the method 75 (FIG. 15), the method 80 (FIG. 16), the method 90 (FIG. 17), the method 100 (FIG. 18), the method 110 (FIG. 19), and/or the method 120 (FIG. 20), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 22, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

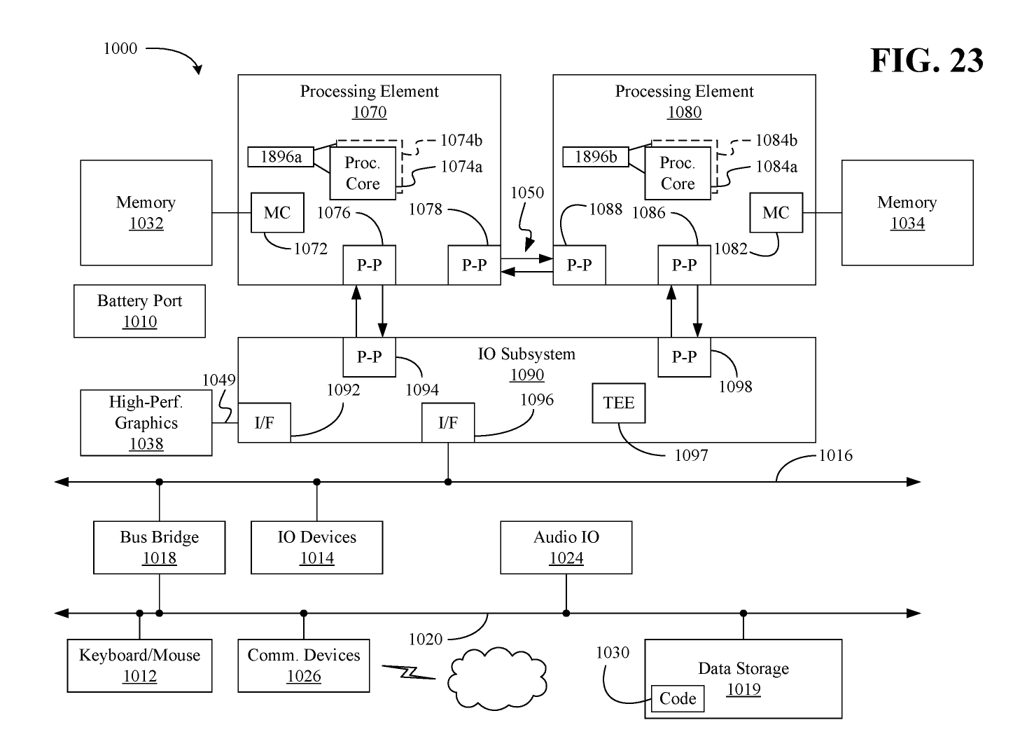

Referring now to FIG. 23, shown is a block diagram of a system 1000 embodiment in accordance with an embodiment. Shown in FIG. 23 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 23 may be implemented as a multi-drop bus rather than point-to-point interconnect.

As shown in FIG. 23, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 22.

Each processing element 1070, 1080 may include at least one shared cache 1896a, 1896b (e.g., static random access memory/SRAM). The shared cache 1896a, 1896b may store data (e.g., objects, instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 23, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 23, the I/O subsystem 1090 includes a TEE 1097 (e.g., security controller) and P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 23, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement one or more aspects of the method 30 (FIGS. 3A to 3C), the method 50 (FIG. 5), the method 60 (FIG. 6), the method 70 (FIG. 14), the method 75 (FIG. 15), the method 80 (FIG. 16), the method 90 (FIG. 17), the method 100 (FIG. 18), the method 110 (FIG. 19), and/or the method 120 (FIG. 20), already discussed, and may be similar to the code 213 (FIG. 22), already discussed. Further, an audio I/O 1024 may be coupled to second bus 1020.

Note that other embodiments are contemplated. For example, instead of the point-to-point architecture of FIG. 23, a system may implement a multi-drop bus or another such communication topology.

### ADDITIONAL NOTES AND EXAMPLES

Example 1 may include an electronic processing system, comprising a processor, memory communicatively coupled to the processor, and logic communicatively coupled to the processor to test a target query for one or more similarity metrics over a range of parameters for one or more sets of sequence related information, a multi-domain sequence model, and one or more training routines, and select a set of parameters based on a result of the test.

Example 2 may include the system of Example 1, wherein the logic is further to automatically configure the multi-domain sequence model to adapt to one or more of respective data sets, respective prediction tasks, and respective recommendation tasks based on the selected parameters.

Example 3 may include the system of Example 1, wherein the one or more similarity metrics comprise multi-domain similarity metrics.

Example 4 may include the system of Example 3, wherein the multi-domain similarity metrics comprise averaged log-loss similarity metrics.

Example 5 may include the system of any of Examples 1 to 4, wherein the multi-domain sequence model comprises a variable order context-tree model.

Example 6 may include the system of Example 5, wherein the sequence related information includes one or more of time series data, temporal event sequence information, and symbolic sequence information.

Example 7 may include a semiconductor package apparatus, comprising one or more substrates, and logic coupled to the one or more substrates, wherein the logic is at least partly implemented in one or more of configurable logic and fixed-functionality hardware logic, the logic coupled to the one or more substrates to test a target query for one or more similarity metrics over a range of parameters for one or more sets of sequence related information, a multi-domain sequence model, and one or more training routines, and select a set of parameters based on a result of the test.

Example 8 may include the apparatus of Example 7, wherein the logic is further to automatically configure the multi-domain sequence model to adapt to one or more of respective data sets, respective prediction tasks, and respective recommendation tasks based on the selected parameters.

Example 9 may include the apparatus of Example 7, wherein the one or more similarity metrics comprise multi-domain similarity metrics.

Example 10 may include the apparatus of Example 9, wherein the multi-domain similarity metrics comprise averaged log-loss similarity metrics.

Example 11 may include the apparatus of any of Examples 7 to 10, wherein the multi-domain sequence model comprises a variable order context-tree model.

Example 12 may include the apparatus of Example 11, wherein the sequence related information includes one or more of time series data, temporal event sequence information, and symbolic sequence information.

Example 13 may include the apparatus of Example 7, wherein the logic coupled to the one or more substrates includes transistor channel regions that are positioned within the one or more substrates.

Example 14 may include a method of automatically configuring a model, comprising testing a target query for one or more similarity metrics over a range of parameters for one or more sets of sequence related information, a multi-domain sequence model, and one or more training routines, and selecting a set of parameters based on a result of the test.

Example 15 may include the method of Example 14, further comprising automatically configuring the multi-domain sequence model to adapt to one or more of respective data sets, respective prediction tasks, and respective recommendation tasks based on the selected parameters.

Example 16 may include the method of Example 14, wherein the one or more similarity metrics comprise multi-domain similarity metrics.

Example 17 may include the method of Example 16, wherein the multi-domain similarity metrics comprise averaged log-loss similarity metrics.

Example 18 may include the method of any of Examples 14 to 17, wherein the multi-domain sequence model comprises a variable order context-tree model.

Example 19 may include the method of Example 18, wherein the sequence related information includes one or more of time series data, temporal event sequence information, and symbolic sequence information.

Example 20 may include at least one computer readable medium, comprising a set of instructions, which when executed by a computing device, cause the computing device to test a target query for one or more similarity metrics over a range of parameters for one or more sets of sequence related information, a multi-domain sequence model, and one or more training routines, and select a set of parameters based on a result of the test.

Example 21 may include the at least one computer readable medium of Example 20, comprising a further set of instructions, which when executed by the computing device, cause the computing device to automatically configure the multi-domain sequence model to adapt to one or more of respective data sets, respective prediction tasks, and respective recommendation tasks based on the selected parameters.

Example 22 may include the at least one computer readable medium of Example 20, wherein the one or more similarity metrics comprise multi-domain similarity metrics.

Example 23 may include the at least one computer readable medium of Example 22, wherein the multi-domain similarity metrics comprise averaged log-loss similarity metrics.

Example 24 may include the at least one computer readable medium of any of Examples 20 to 23, wherein the multi-domain sequence model comprises a variable order context-tree model.

Example 25 may include the at least one computer readable medium of Example 24, wherein the sequence related information includes one or more of time series data, temporal event sequence information, and symbolic sequence information.

Example 26 may include an automatic configuration apparatus, comprising means for testing a target query for one or more similarity metrics over a range of parameters for one or more sets of sequence related information, a multi-domain sequence model, and one or more training routines, and means for selecting a set of parameters based on a result of the test.

Example 27 may include the apparatus of Example 26, further comprising means for automatically configuring the multi-domain sequence model to adapt to one or more of respective data sets, respective prediction tasks, and respective recommendation tasks based on the selected parameters.

Example 28 may include the apparatus of Example 26, wherein the one or more similarity metrics comprise multi-domain similarity metrics.

Example 29 may include the apparatus of Example 28, wherein the multi-domain similarity metrics comprise averaged log-loss similarity metrics.

Example 30 may include the apparatus of any of Examples 26 to 29, wherein the multi-domain sequence model comprises a variable order context-tree model.

Example 31 may include the apparatus of Example 30, wherein the sequence related information includes one or more of time series data, temporal event sequence information, and symbolic sequence information.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

we claim:

1. An electronic processing system, comprising:
a processor;
memory communicatively coupled to the processor; and
logic communicatively coupled to the processor to:
test a target query for one or more similarity metrics over a range of parameters for one or more sets of sequence related information, a multi-domain sequence model, and one or more training routines,
select a set of parameters based on a result of the test, and
automatically configure the multi-domain sequence model to adapt to one or more of respective data sets, respective prediction tasks, and respective recommendation tasks based on the selected parameters.

2. The system of claim 1, wherein the logic is further to:
split an input data into a training data set and a test data set;
select a plurality of configuration parameters based on query type of the target query and a plurality of training data selected from the training data set;
transform variables of the selected plurality of configuration parameters into sequences of symbols; and
update the multi-domain sequence model using the transformed variable.

3. The system of claim 1, wherein the one or more similarity metrics comprise multi-domain similarity metrics.

4. The system of claim 3, wherein the multi-domain similarity metrics comprise averaged log-loss similarity metrics.

5. The system of claim 1, wherein the multi-domain sequence model comprises a variable order context-tree model.

6. The system of claim 1, wherein the sequence related information includes one or more of time series data, temporal event sequence information, and symbolic sequence information.

7. A semiconductor package apparatus, comprising:
one or more substrates; and
logic coupled to the one or more substrates, wherein the logic is at least partly implemented in one or more of configurable logic and fixed-functionality hardware logic, the logic coupled to the one or more substrates to:
test a target query for one or more similarity metrics over a range of parameters for one or more sets of sequence related information, a multi-domain sequence model, and one or more training routines,
select a set of parameters based on a result of the test, and
automatically configure the multi-domain sequence model to adapt to one or more of respective data sets, respective prediction tasks, and respective recommendation tasks based on the selected parameters.

8. The apparatus of claim 7, wherein the logic is further to:
split an input data into a training data set and a test data set;
select a plurality of configuration parameters based on query type of the target query and a plurality of training data selected from the training data set;
transform variables of the selected plurality of configuration parameters into sequences of symbols; and
update the multi-domain sequence model using the transformed variable.

9. The apparatus of claim 7, wherein the one or more similarity metrics comprise multi-domain similarity metrics.

10. The apparatus of claim 9, wherein the multi-domain similarity metrics comprise averaged log-loss similarity metrics.

11. The apparatus of claim 7, wherein the multi-domain sequence model comprises a variable order context-tree model.

12. The apparatus of claim 7, wherein the sequence related information includes one or more of time series data, temporal event sequence information, and symbolic sequence information.

13. The apparatus of claim 7, wherein the logic coupled to the one or more substrates includes transistor channel regions that are positioned within the one or more substrates.

14. A method of automatically configuring a model, comprising:
testing a target query for one or more similarity metrics over a range of parameters for one or more sets of sequence related information, a multi-domain sequence model, and one or more training routines;
selecting a set of parameters based on a result of the test; and
automatically configuring the multi-domain sequence model to adapt to one or more of respective data sets, respective prediction tasks, and respective recommendation tasks based on the selected parameters.

15. The method of claim 14, further comprising:
splitting an input data into a training data set and a test data set;
selecting a plurality of configuration parameters based on query type of the target query and a plurality of training data selected from the training data set;
transforming variables of the selected plurality of configuration parameters into sequences of symbols; and
updating the multi-domain sequence model using the transformed variable.

16. The method of claim 14, wherein the one or more similarity metrics comprise multi-domain similarity metrics.

17. The method of claim 16, wherein the multi-domain similarity metrics comprise averaged log-loss similarity metrics.

18. The method of claim 14, wherein the multi-domain sequence model comprises a variable order context-tree model.

19. The method of claim 14, wherein the sequence related information includes one or more of time series data, temporal event sequence information, and symbolic sequence information.

20. At least one computer readable medium, comprising a set of instructions, which when executed by a computing device, cause the computing device to:
test a target query for one or more similarity metrics over a range of parameters for one or more sets of sequence related information, a multi-domain sequence model, and one or more training routines;
select a set of parameters based on a result of the test; and
automatically configure the multi-domain sequence model to adapt to one or more of respective data sets, respective prediction tasks, and respective recommendation tasks based on the selected parameters.

21. The at least one computer readable medium of claim 20, comprising a further set of instructions, which when executed by the computing device, cause the computing device to:
split an input data into a training data set and a test data set;
select a plurality of configuration parameters based on query type of the target query and a plurality of training data selected from the training data set;
transform variables of the selected plurality of configuration parameters into sequences of symbols; and
update the multi-domain sequence model using the transformed variable.

22. The at least one computer readable medium of claim 20, wherein the one or more similarity metrics comprise multi-domain similarity metrics.

23. The at least one computer readable medium of claim 22, wherein the multi-domain similarity metrics comprise averaged log-loss similarity metrics.

24. The at least one computer readable medium of claim 20, wherein the multi-domain sequence model comprises a variable order context-tree model.

25. The at least one computer readable medium of claim 20, wherein the sequence related information includes one or more of time series data, temporal event sequence information, and symbolic sequence information.
